(19) United States
(12) Patent Application Publication
(10) Pub. No.: US 2002/0000732 A1
(43) Pub. Date: Jan. 3, 2002

(54) Pick-up box extension

(76) Inventor: Hans W. Sanders, St. Basile (CA)

Correspondence Address: Hans W. Sanders, 99 Richelieu, St. Basile, QC, J3N 1M4, CA

(21) Appl. No.: 09/812,855

(22) Filed: Mar. 21, 2001

(51) Int. Cl. B62C 1/06

(52) U.S. Cl. 296/26.08

(57) ABSTRACT

A device consisting of three panels, a rear panel and two side panels, hinged to the tailgate of a pick-up truck and to each other in such a manner that when unfolded and secured with the tailgate in a lowered position, it results in an increased and enclosed area of the pick-up box to permit carrying oversized objects by pick-up trucks with six foot or eight foot nominal length boxes. The device can be hinged downward when the tailgate is in a lowered, horizontal position thereby not obstructing the loading or unloading process. The device folds for storage against the closed tailgate by means of adjustable hinges, taking a minimum of space when not in use without unduly obstructing the pick-up box loading area. The dimensions of the panels vary in height, length and width in relation to the dimensions of pick-up truck boxes of various manufacturers and models.

Materials chosen may be of any kind such as, but not limited to, steel, plastic or wood and painted to suit requirements with suitable lights and/or reflectors installed. The device provides an enclosed, increased loading area for pick-up trucks beyond the extreme end of the open tailgate and enhances road safety and can be installed as an aftermarket items or incorporated into the original manufactured vehicles.

### FIELD OF THE INVENTION

The invention relates to a pick-up box extension for use with various size vehicles having a peripherally enclosed area accessible by means of a tailgate.

### BACKGROUND OF THE INVENTION

With the advent of downsized pick-up trucks and extended cabs came a need for an extension of the pick-up truck bed loading area beyond the open tailgate. A need arose to provide a practical means to carry standard size construction materials or other items in an enclosed and safe manner, without unduly restricting the regular loading area when the tailgate is in a closed vertical position.

### SUMMARY OF THE INVENTION

The invention is an improved pick-up box extension that allows transportation of oversized items that would normally not fit into the existing pick-up box enclosure or existing enclosures that terminate at the extreme rearward end of the horizontal tailgate.

The device attaches to vehicles having a loading platform with opposing vertical sides and a tailgate that hinges to the horizontal position from its closed vertical position.

The device consists of a rear panel of rectangular configuration and two rectangular side panels hinged to the opposite ends of the rear panel thus permitting movement of the side panels from a position parallel to the rear panel to a position of approximately ninety degrees to the horizontal plane of the rear panel.

The longitudinal dimension of the rectangular rear panel is such that it is somewhat smaller than the distance between the existing tailgate supports and the longitudinal dimensions of the side panel are somewhat smaller than half the longitudinal dimension of the rear panel permitting both side panels to be folded into the position parallel to the rear panel without overlap thus forming a flat configuration against the rear panel when said side panels are in the folded self-storing position.

The assembly of one rear panel and two hinged side panels are attached to two or more asymmetric hinges the short side of which are attached to the lower longitudinal edge of the rear panel. The rear panel contacts the inside of the horizontal tailgate and the longer side of the said hinges are held in place against the inside surface of the horizontal tailgate by means of brackets bridging the long side of the hinges and are attached to the inside surface of the tailgate. This permits the long side of the hinges to slide fore and aft in respect to the longitudinal axis of the vehicle resulting in an extended position of the rear panel beyond the outer extremity of the horizontal tailgate when the pick-up box extension is in its deployed position.

The asymmetric hinges are of such configuration that they can swivel ninety degrees up or down from their fully open position. This permits the rear and side panel assembly to assume a position parallel to the inside surface to the tailgate when in the self-storing position and also permits the said assembly to pivot ninety degrees downward when the tailgate is in its open horizontal position. This configuration does not interfere with the loading and off-loading operations.

In its self-storing position, the pick-up box extension assumes a position flat against and parallel to the closed vertical tailgate and is held in place by the sliding asymmetric hinges. The rear panel covers the two side panels and is further prevented from movement by a locking mechanism preventing vibration against the tailgate.

Operational deployment of the pick-up box extension entails opening the tailgate to its horizontal position, releasing the rear panel hold-down lock, positioning the rear panel by means of the asymmetric hinges to a position more or less vertical to the horizontal tailgate, positioning the side panels by means of their hinges attached to opposing ends of the rear panel to a vertical position at more or less ninety degree angles to the rear panel, sliding the open assembly rearward until the locking mechanism in both side panels aligns with the existing tailgate locking devices at the existing vertical sidewalls of the vehicle and securing the side panels in this position by means of suitable fasteners. Stop bolts in the long portion of the asymmetric hinge contact the hold-down brackets and prevent overextension of the assembly.

The pick-up box extension may be fabricated from sheet metal with suitable bends and reinforcing ribs in accordance with good engineering practices or made of aluminum, plastic, wood or other materials deemed suitable for the purpose. Safety lights and reflectors along with appropriate paints may be added to suit requirements.

In this way, the invention creates a simple cost effective way to solve the problem of an insufficient enclosed and secure loading area for pick-up trucks or station wagons.

### DESCRIPTION OF SEVERAL VIEWS OF THE DRAWINGS

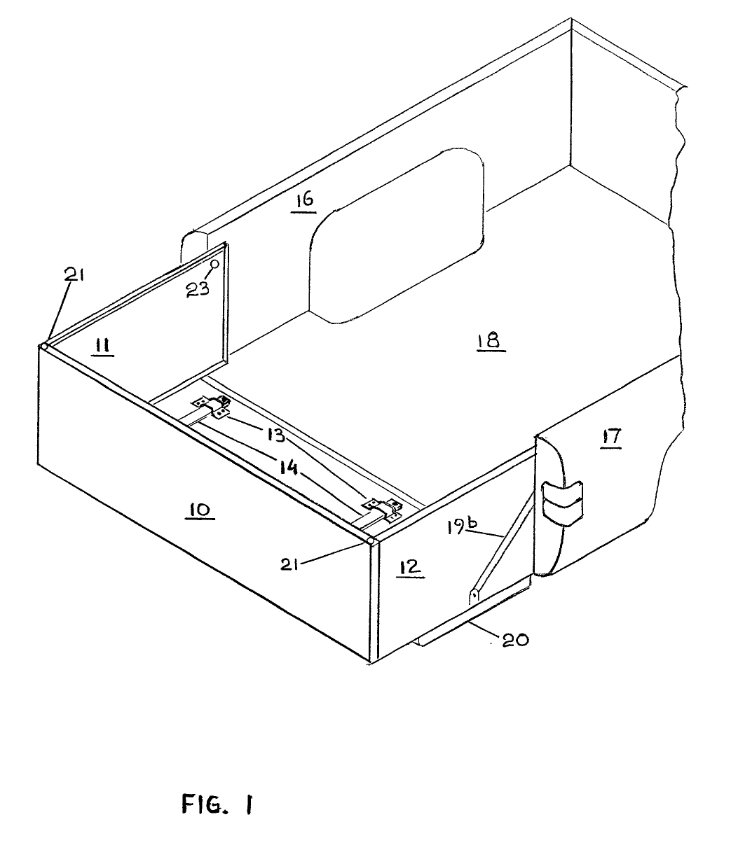

SHEET No. 1/4 FIG. 1 depicts a perspective view of an existing pick-up box with the Pick-up Box Extension deployed and fastened in place.

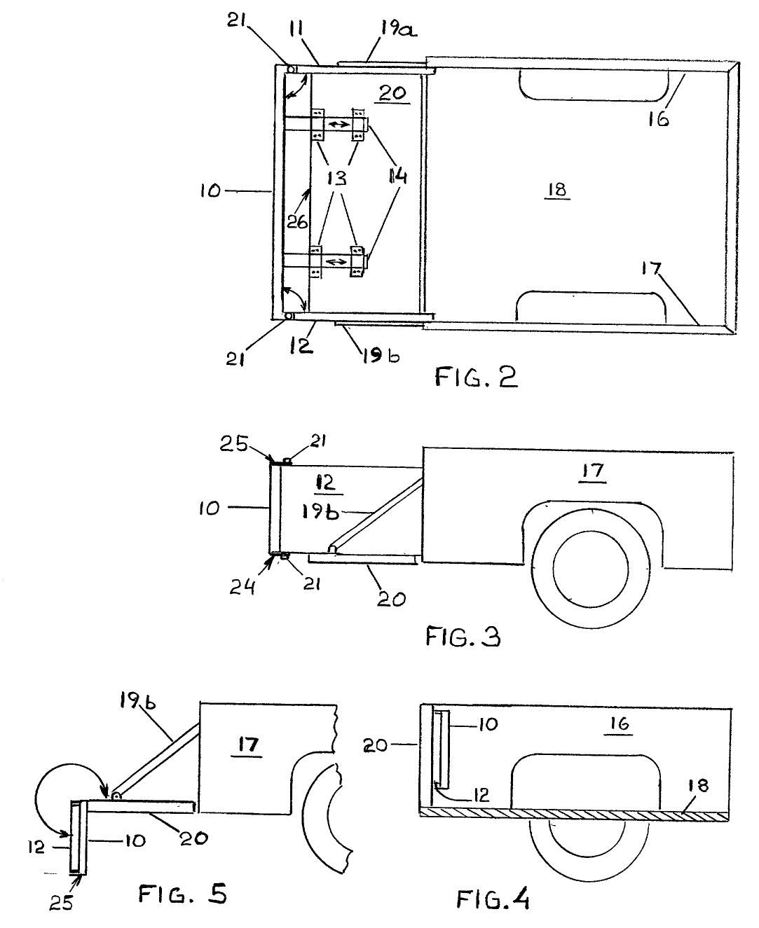

SHEET No. 2/4 FIG. 2 shows a top view of the Pick-up Box Extension with hinged side panels and sliding hinges affixed in place.

SHEET No. 2/4 FIG. 3 shows a side view of the Pick-up Box Extension extending beyond the horizontal tailgate.

SHEET No. 2/4 FIG. 4 shows a side view of the Pick-up Box Extension in the collapsed self-storing position against the existing closed tailgate. The right hand sidewall of the pick-up truck box is removed for clarity.

SHEET No. 2/4 FIG. 5 shows the collapsed Pick-up Box Extension hinged vertically downward from the open horizontal tailgate to permit loading or unloading of the pick-up box.

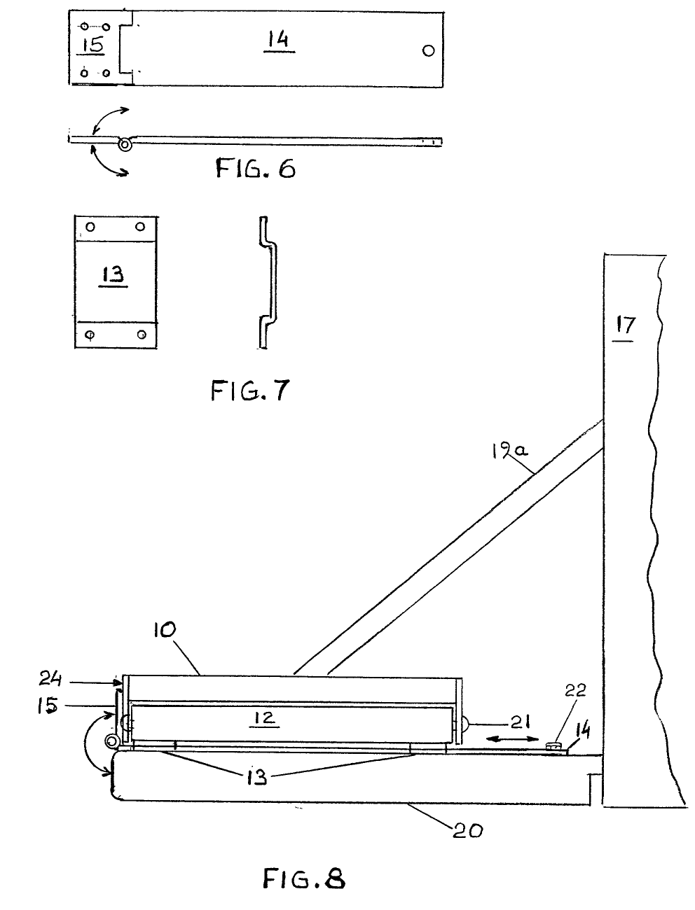

SHEET No. 3/4 FIG. 6 shows an enlarged view of the asymmetric sliding hinge.

SHEET No. 3/4 FIG. 7 shows an enlarged view of the hinge-retaining bracket.

SHEET No. 3/4 FIG. 8 shows an enlarged view of the open horizontal tailgate with the Pick-up Box Extension in a folded, self-storing, retracted position fiat against the tailgate. It also shows the position of the stop bolt (item 22) that prevents in-adverted overextension of the sliding hinge. The right hand tailgate support is omitted for clarity.

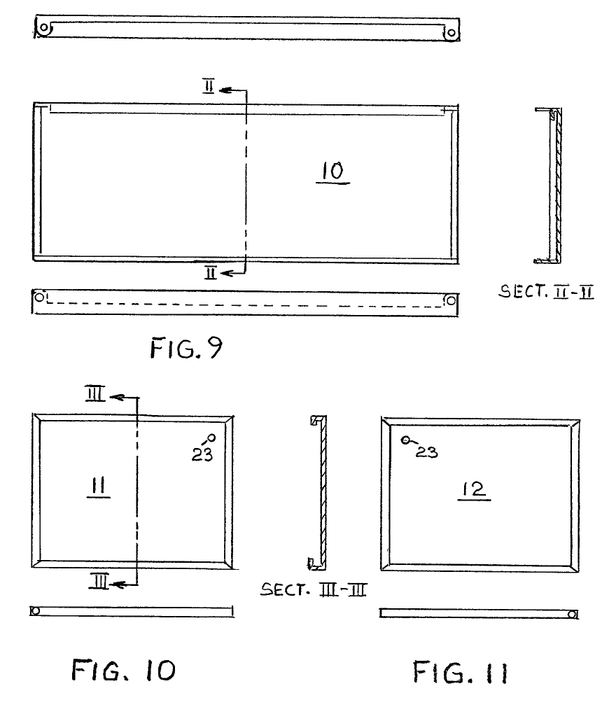

SHEET No. 4/4 FIG. 9 shows the typical sheet metal construction of the rear panel.

SHEET No. 4/4 FIG. 10 and FIG. 11 show the typical sheet metal construction of the left hand and right hand side panels.

### DETAILED DESCRIPTION OF THE PREFERRED EMBODIMENTS

The following description is made with reference to drawings on SHEET No. 1/4 to 4/4 inclusive.

The perspective view shown in FIG. 1 depicts an existing loading platform with a loading surface 18, a left sidewall 16, a right sidewall 17 and a hinged tailgate 20 opened to the horizontal position and held in place by tailgate supports 19a and 19b.

The pick-up box extension is seen mounted in its fully deployed functional position and consists of a rectangular rear panel 10 sized to fit between tailgate supports 19a and 19b. A left hand side panel 11 of rectangular shape having a long side somewhat smaller than half the long side of the rear panel 10 and has one end attached by hinges to one end of the rear panel 10 by means of hinge pins 21 permitting rotation of said side panel 11 about the axis of hinge pin 21 from a position parallel with the rear panel 10 to a position more or less vertical to the horizontal plane of the rear panel 10. The opposite end of rear panel 11 is secured to the existing tailgate latching mechanism by means of fasteners suited to be removably put in place at station 23.

The right hand side panel 12 is the mirror image of the side panel 11 and is hingedly secured to the opposite end of the rear panel 10 by means of hinge pins 21 permitting rotation of the side panel 12 about the axis of the hinge pins 21 from a parallel position in respect to the rear panel 10 to a position more or less vertical to the horizontal plane of the rear panel 10. The opposite end of the side panel 12 removably affixes to the existing sidewall 17 in the same manner as described for side panel 11.

Sliding asymmetric hinges 14 are permanently secured to the rear panel 10 and are held in place against the inner surface of the tailgate 20 by means of brackets 13 fastened to tailgate 20, bridging the long arm of asymmetric hinges 14 and permitting movement fore and aft along the longitudinal axis of the existing vehicle to permit alignment of the side panels 11 and 12 with the existing latching mechanism of sidewalls 16 and 17 at station 23.

An enlarged view of the collapsed pick-up box extension assembly is shown in its self-storing position parallel with the horizontal tailgate 20 in FIG. 8 showing asymmetric hinges 14 held in position against the inside surface of the tailgate 20 by means of hinge retaining brackets 13 affixed to the tailgate 20 in such position as to permit rearward extension of said assembly and permit latching of the side panels 11 and 12 at station 23 to sidewalls 16 and 17. Stop bolts or similar fasteners 22 are affixed to the asymmetric hinges 14 at a suitable position to prevent overextension of said assembly.

The short portion 15 of asymmetric hinge 14 is permanently fastened to the bottom longitudinal edge 24 of the rear panel 10 by means of fasteners, welding or bonding. The design of the rear panel 10 is such that it can house both side panels 11 and 12 when said panels are rotated about hinge pins 21 to a position parallel with the rear panel 10. For clarity, FIG. 8 does not show the tailgate support 19b.

FIG. 2 shows a top view of the existing loading platform defined by loading surface 18, sidewalls 16 and 17, horizontally open tailgate 20 held in place by supports 19a and 19b. One clearly sees the deployed pick-up box extension, consisting of rear panel 10, side panels 11 and 12, hinges 13 and 21 and brackets 14, extending beyond the extreme end 26 of tailgate 20, thereby increasing the useful peripherally enclosed area by a large factor made possible by the use of the suitably sized asymmetric hinges 14 and suitably sized sidewalls 11 and 12, and hinge retaining brackets 13 that permit hinges 14 to slide fore and aft along the vehicle's longitudinal axis when side panels 11 and 12 are unlatched from sidewalls 16 and 17.

The side view FIG. 3 shows the deployed pick-up box extension resting partially on the open tailgate 20 with edges 25 and 24 of the rear panel 10 overlapping side panels 11 and 12 and being hingedly connected to rear panel 10 by means of hinge pins 21.

Unlatching side panel 11 and 12 at stations 23 from sidewalls 16 and 17 permits rotation of side panels 11 and 12 about hinge pins 21 to a position parallel with the rear panel 10 which in turn is rotated about the axis of asymmetric hinges 14 to a position parallel with the inside surface of the open tailgate 20 and the whole collapsed assembly consisting principally of the rear panel 10 and side panels 11 and 12 is slid forward by means of asymmetric hinges 13 and bridging hinge retaining brackets 14 until said assembly is approximately flush with the tailgate edge 26 and said assembly is secured in this position by a suitable latching mechanism against the inside surface of tailgate 20.

The tailgate 20 is then rotated about its hinging mechanism to a vertical position and latched to sidewalls 16 and 17. The collapsed pick-up box extension assembly is thus stored flat against the closed tailgate 20 as shown in FIG. 4 without encumbering the vehicle's original loading area. Deployment of the collapsed pick-up box extension from its self-storing position follows operations in reverse order as described.

In order to load or offload items with the tailgate 20 in a horizontal position, the collapsed pick-up box extension is unlatched from its position parallel to the inside surface of the tailgate 20 and rotated vertically downward about the axis of the asymmetric hinges 14 as shown in FIG. 5 thereby not interfering with operations.

Preferred materials are sheet metal for the rear panel 10, left hand side panel 11, right hand side panel 12, asymmetric hinges 14 and brackets 13 although any other suitable material may be chosen. Typical configurations in accordance with good engineering design practices are shown in FIG. 6, FIG. 7, FIG. 9, FIG. 10, and FIG. 11 for asymmetric hinges 14, hinge-retaining brackets 13, rear panel 10, left hand side panel 11 and right hand side panel 12 respectively. Other suitable configurations and designs may be used to achieve the same ends.

The pick-up box extension may be painted and rear panel 10 and side panels 11 and 12 may be equipped with lights and or reflectors to enhance appeal, corrosion resistance and road safety.

The aforegoing embodiment of the presented invention sets out in detail the nature and function of the invention. It may however be apparent to those skilled in the art that changes may be made to some details of the invention without departing from the spirit and principles of the invention.

| Item Number | Description |
|---|---|
| 10 | Rear Panel |
| 11 | Left Hand Side Panel |
| 12 | Right Hand Side Panel |
| 13 | Hinge-Retaining Bracket |
| 14 | Asymmetric Sliding Hinge-Long End |
| 15 | Asymmetric Sliding Hinge-Short End |
| 16 | Existing Left Hand Wall of Pick-Up Box |
| 17 | Existing Right Hand Wall of Pick-Up Box |
| 18 | Existing Floor of Pick-Up Box |
| 19a | Existing Right Hand Tailgate Support |
| 19b | Existing Left Hand Tailgate Support |
| 20 | Existing Tailgate |
| 21 | Rear Panel to Side Panel Hinge Pin |
| 22 | Sliding Hinge Stop Bolt |
| 23 | Locking Mechanism |
| 24 | Lower Edge of Rear Panel 10 |
| 25 | Upper Edge of Rear Panel 10 |
| 26 | Upper Edge of Tailgate 20 |

What I claim is:

1. A pick-up box extension for use on vehicles having a loading area defined by a floor section, two opposing vertical longitudinal sidewalls, a cross wall vertical to the floor section and connecting the sidewalls at right angles at the most forward station of the sidewalls and a conventional tailgate hinged to the floor section permitting movement of the tailgate about the hinge axis from a position vertical to the floor section and at right angles to the sidewalls to a position horizontal with the floor section and restrained in this position by supports attached to opposing ends of the tailgate and to the sidewalls.

2. A pick-up box extension having a rectangular rear panel and two shorter rectangular side panels hingedly attached to said rear panel at opposing ends permitting movement of the hinged side panels about the hinge axis from a position parallel with the rear panel to a position of more or less ninety degrees with the rear panel.

3. A pick-up box extension attached to the tailgate by means of sliding asymmetric hinges permitting rotation of said pick-up box extension about the asymmetric hinge axis from a position parallel to the horizontal open tailgate to a position vertically up or down from the horizontal tailgate.

4. A pick-up box extension that positions the rectangular rear panel by means of the sliding asymmetric hinges substantially beyond the extreme end of the open tailgate thereby peripherally enclosing a much larger loading area than other devices.

5. A pick-up box extension that folds flat and parallel against the inside surface of the tailgate thereby requiring a minimal amount of storage space.

6. A pick-up box extension that does not reduce the usefulness of the original loading surface when retracted to its self-storing position.

7. A pick-up box extension that swings out of the way for loading and offloading purposes when the tailgate is in a lowered horizontal position.

8. A pick-up box extension having two rectangular side panels hingedly attached to the opposite ends of the rectangular rear panel enabling said side panels to be rotated about said hinges from a position parallel with the rear panel to a position vertical to the rear panel and attaching the ends opposite to the hinged side to existing attachment points at the existing sidewalls of the existing vehicle by means of latching mechanisms adapted to the configuration of the existing vehicle.

9. A pick-up box extension that is attached to the tailgate by means of two or more asymmetric sliding hinges and hinge retaining brackets which permit said extension to move fore and aft along the longitudinal axis of the vehicle providing an enlarged loading area when said extension is in its fully deployed position and permits said extension to be stored flush against and parallel to the closed tailgate, without unduly reducing the original vehicle loading area.

10. A pick-up box extension that can be painted and provided with lights and/or reflectors to suit requirements.

11. A pick-up box extension that can be manufactured as an aftermarket item or that can be incorporated in the tailgates of the original manufacturer's vehicles at the point of production.

12. A pick-up box extension that can easily be removed and re-installed from the vehicle by removal or reinstallation of the stop fasteners.

13. A pick-up box extension that can be fabricated from sheet metal or any other suitable material in accordance with good engineering practices.
